(19) United States
(12) Patent Application Publication
(10) Pub. No.: US 2017/0074217 A1
(43) Pub. Date: Mar. 16, 2017

(54) FUEL SAVER AND CONTAMINANTS REDUCER SYSTEM AND METHOD

(71) Applicant: Carlos Almonte Pena, Ft. Lauderdale, FL (US)

(72) Inventor: Carlos Almonte Pena, Ft. Lauderdale, FL (US)

(21) Appl. No.: 14/849,752

(22) Filed: Sep. 10, 2015

(51) Int. Cl. F02M 27/04; F15D 1/00; F15D 1/06

(52) U.S. Cl. CPC F02M 27/045; F15D 1/06; F15D 1/0065

(57) ABSTRACT

A fuel saver and contaminant reduction device, comprising: a cylindrical housing with a tubular fuel conduit through which the fuel flows, the pipe with a fuel inlet in fluid communication with the fuel tank of a vehicle, and a fuel outlet in fluid communication with the fuel line feeding into a vehicle's engine. The cylindrical body including at least two sets of aligned transversal orifices in each of which a permanent magnet is inserted where each magnet includes distinct north and south poles. Each pair of permanent magnets is arranged such that a north pole of each magnet faces the other, and the axis of magnetization is perpendicular to the flow of fuel. The cylindrical housing is covered by an external rigid case.

### FIELD OF THE INVENTION

The present invention relates to a device for creating a magnetic field on a flow of fuel coming from the fuel tank to the fuel intake of the vehicle's engine, to enhance vehicle performance, save fuel and reduce the amount of contaminants created by the fuel combustion. More particularly, the present invention relates to a device for improving the efficiency of an internal combustion engine by using permanent magnets to impose magnetic energy upon fuel molecules flowing through the device en route to a combustion chamber prior to combustion therein.

### DESCRIPTION OF THE PRIOR ART

Increasing the fuel efficiency of internal combustion engines has been a main concern in the automotive industry. Particularly after each oil crisis, when the gas prices go up affecting the economy, automakers reinforce their campaigns to develop more efficient engines. Hybrid engines are one of the latest achievements in this respect.

Many and diverse devices are known in the art which claim to increase the efficiency of fuel consumption by applying magnetic fields to a fuel mixture prior to the mixture's combustion. For example, a device for improving fuel efficiency that includes at least one magnet for magnetically orienting fuel fluids fed through a fluid passageway into a combustion chamber of an apparatus with which the device is used. This device includes a housing containing one permanent magnet adjacent to the fluid passageway. The goal of this device is to create a magnetic field responsible for improved fuel efficiency, an improved power production, a reduction of carbon build-up on engine parts, and a reduction of pollutants normally found in combustion exhaust gases.

Another example is a fuel treatment device comprising a fuel line and a pair of magnets positioned at an inlet for incoming fuel. Each of the magnets is positioned with its south magnetic pole arranged to face upstream of the fuel line and its north magnetic pole placed closest to a mixing zone. The south magnetic pole generates a flux that affects the fuel flow, and then the flux of the opposed north magnetic pole allegedly improving combustion efficiency.

Also known is a magnetic fuel treatment device comprising a magnet embedded in a non-magnetic body adapted to fit over a fuel line. The magnet is positioned so that its north magnetic pole is spaced apart from the fuel line and its south magnetic pole is adjacent to the fuel line. In this case, the flux imposed by the magnet's south pole also affects the fuel as in the previous cases.

A magnetizing apparatus is known in the market to apply a magnetic field to fuel to impart a magnetic flux density of at least 10 gauss to the fuel. In this particular embodiment, a group of magnets are arranged within a casing and oriented such that magnetic forces are produced and directed to the fuel to be processed. Similar to the previous cases, the fuel is processed as it flows past the casing, and preferably, is also arranged to impart the device's diametrically opposed field to any steam or air to be mixed with the fuel at combustion.

Another known embodiment comprises at least one magnet in a fuel fluid passageway, with its north pole proximate and/or facing the fuel passageway in order that the magnetizing force imposed by the north pole of the magnet negatively charges the fuel for combustion. The fluid passageway and magnet are housed in a casing with a casing cover, including two magnets arranged in the chamber in diametric opposition.

One known result of creating diametrically opposed magnetic fields directed by the physical arrangement of the permanent magnetic pairs is their effect on the downsizing of large hydrocarbon molecules present in the liquid fuel mixture to smaller molecules. The size of molecules comprising the fuel mixture limits any geometry in which such molecules can possibly arrange themselves as a fluid mass. Thus, the molecular arrangement directly affects the velocity of the fuel, atomization of the fluid mass at the combustion chamber, fuel molecule ignition and fuel molecule combustion.

Another known result of applying magnetic fields as part of techniques for the treatment of liquids flowing through a pipe, particularly water or fuel, is the creation of a phenomenon called polarization. This is especially useful to avoid the problems that usually occur in pipes such as the appearance of lime in water pipes or the appearance of carbon deposits produced by combustion in boilers and internal combustion engines.

In the latter field, it is important in reducing not only the production of carbon deposits but also the application of magnetic fields suitably designed for each application that may entail significant reductions in consumption due to the increase in combustion efficiency.

The fuel has the tendency of forming large chains of molecules that tend to clump, hindering proper oxygenation after atomization.

Applying a magnetic field to the fuel eliminates such groups of large molecules; allowing further improvement in the mixing process and results in a higher yield. Also, the ionic additives are polarized by the presence of such a magnetic field favoring the mixture of molecules, keeping it in suspension so that it becomes a more effective action during their combustion.

Therefore, the present invention is directed to a fuel saver device that overcomes the difficulties and drawbacks of the devices of the prior art.

### SUMMARY OF THE INVENTION

The present invention overcomes the deficiencies of the known art and the problems that remain unsolved by providing an easy-to-install and practical fuel saver and contaminant reduction device with which it is possible to improve the engine's efficiency and reduce the amount of contaminants present in the exhausting gases.

In a first exemplary embodiment, a fuel saver and contaminant reduction device comprising: a magnet retention core comprising at least two pair of transversally aligned orifices and an axially located orifice passing therethrough;

A tubular fuel conduit forming a fuel conduit, the tubular fuel conduit comprising a fuel inlet located at a first end, and a fuel discharge located at a second end, the tubular fuel conduit being assembled through the axially located magnet retention core orifice;

two pair of magnets, each magnet having a distinct north magnetic pole and a distinct south magnetic pole, wherein each pair of permanent magnets is arranged orienting the north magnetic pole of each magnet facing one another, and the axis of magnetization is oriented perpendicular to the tubular fuel conduit;

the cylindrical body is covered by an external case retaining each magnet within each respective orifice.

In a second aspect, the magnetic fields of the two magnet pairs are offset at 90°.

In another aspect, the magnetic fields of the two magnet pairs are offset at any angle.

In yet another aspect, the cylindrical body includes three of more sets of orifices in which magnet pairs offset between each other at any angle are inserted.

In yet another aspect, the tubular fuel conduit is made of aluminum, cooper, or steel.

In yet another aspect, the cylindrical body is made of Teflon®, Nylon® and the like.

In yet another aspect, the magnets are electromagnets.

In yet another aspect, the magnetic fields created by the magnets are increased, directed or concentrated by inserting metallic pieces into the orifices in which the magnets are inserted.

In yet another aspect, the tubular fuel conduit is the fuel pipe of the vehicle.

In yet another aspect, the permanent magnets are covered by an insulating wrap to protect them from the engine's heat.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, in which:

FIG. 1 presents an isometric view of an exemplary fuel saver and contaminant reduction device in accordance with the present invention;

FIG. 2 is a section side view of the assembled fuel saver and contaminant reduction device, wherein the section is taken along section line 2-2 of FIG. 1;

FIG. 3 is a section plan view of the assembled fuel saver and contaminant reduction device, wherein the section is taken along section line 3-3 of FIG. 1;

FIG. 4 is a section view of the exemplary fuel saver and contaminant reduction device, wherein the section is taken along section line 4-4 of FIG. 1; and

FIG. 5 presents an exploded isometric assembly view of the fuel saver and contaminants reduction apparatus, showing in detail the orientation and location of the magnets with respect to a tubular fuel conduit, wherein the tubular fuel conduit is provided for passage of fuel therethrough.

Like reference numerals refer to like parts throughout the several views of the drawings.

### DETAILED DESCRIPTION OF REPRESENTATIVE EMBODIMENTS

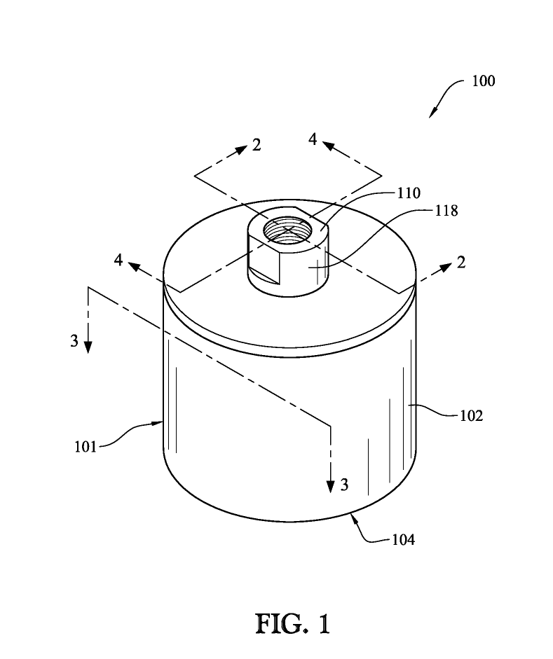

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices illustrated in the attached drawings, and described in the following specification, are simply exemplary embodiments of the inventive concepts defined in the appended claim. Hence, specific dimensions and other physical characteristics relating to the embodiments disclosed herein are not to be considered as limiting, unless the claims expressly state otherwise.

A fuel saver and contaminant reduction device 100, as shown in FIGS. 1 through 5, includes an external casing 101 having a lateral cylindrical wall 102 terminating at a base 104 and a separate upper casing removable cover 103. It is understood that the base 104 can be integrated into the lateral cylindrical wall 102 (as illustrated) or provided as a separate member, similar to the casing removable cover 103. A tubular fuel conduit 110 provides a fluid conduit for fluid to flow therethrough. The tubular fuel conduit 110 is arranged extending axially outward from the casing removable cover 103. The tubular fuel conduit 110 is configured to include a connector 118 formed at each end thereof, wherein the connector 118 that is designed to connect the contaminant reduction device 100 to the fuel system of the vehicle.

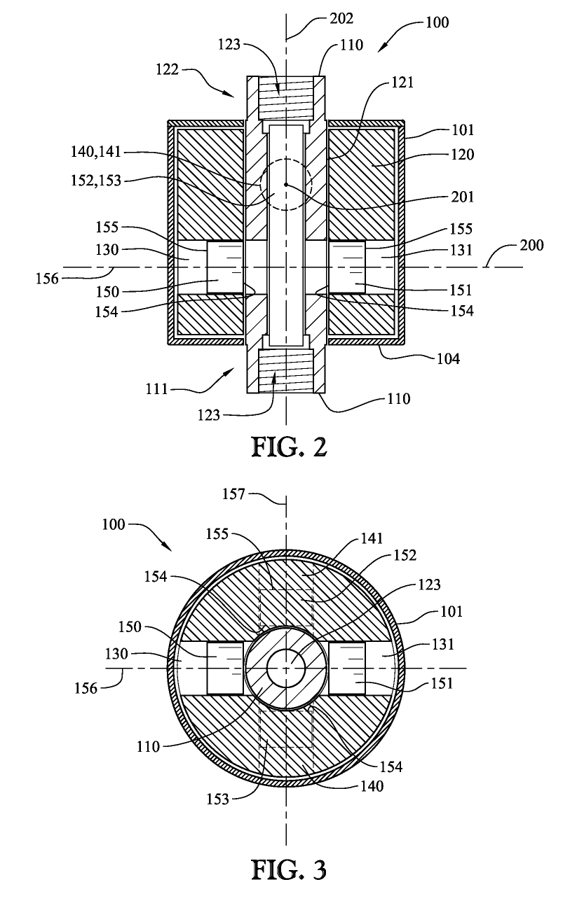

The tubular fuel conduit 110 of the fuel saver and contaminant reduction device 100 (FIG. 2) is inserted into a magnet retention core 120, which is assembled sandwiched between an exterior surface of the tubular fuel conduit 110 and an interior surface of the external casing 101. The magnet retention core 120 includes a longitudinal orifice 121, preferably extending through a central axis of the magnet retention core 120. The magnet retention core 120 additionally includes at least two pair of linearly aligned transversal orifices 130, 131 and 140, 141. The first pair of orifices 130, 131 are located proximate a first end 111 of the pipe 110, and the second pair of orifices 140, 141 are located proximate a second, opposite end 122 of the pipe 120. The geometrical axis 200 of the first pair of orifices 130, 131 is perpendicular to the geometrical axis 201 of the second pair of orifices 140, 141. And a plane defined by the geometrical axis 200 and 201 is, in turn, perpendicular to the geometrical axis 202 of the pipe 110.

The tubular fuel conduit 110 is assembly to the 100# by being inserted through the longitudinal orifice 121. A corresponding permanent magnet 150, 151, 152, and 153 is inserted in a respective orifice 130, 131, 140, 141. The magnets are oriented as follows: a north pole 154 of each magnet 150, 152 faces the north pole 154 of the other, oppositely located magnet of the same pair 151, 153, respectively. The axis of magnetization 156, 157 of each pair of magnets (150, 151) and (152, 153) is perpendicular to the geometric pipe axis 202 or the direction of flow of fuel running through the pipe 110.

The orientation of the orthogonal axis of magnetization 156, 157 of the fuel saver and contaminant reduction device 100 respective to the position of the orifices 130, 131, 140, 141 are clearly shown in the section view of FIG. 3. Also the magnets 150, 151, 152, 153 in each orifice 130, 131, 140, 141 are inserted deep into each orifice, being positioned proximate the tubular fuel conduit 110. This configuration emits a magnetic field about the interior passageway 123 of the tubular fuel conduit 110. The configuration maximizes the effect of the magnetic field upon the fuel molecules as the fuel passes through the passage 123.

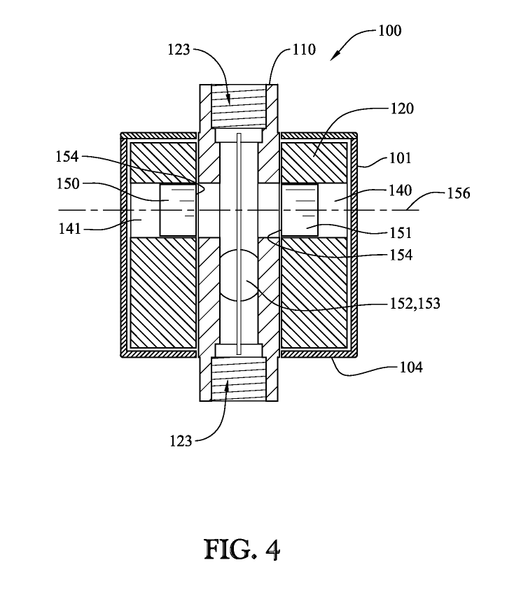

A clear illustration of the position of the orifices 140, 141 with respect to the central passage 123 is presented in FIG. 4, which illustrates a cross sectional view of the fuel saver and contaminant reduction device 100 taken along section line 4-4 of FIG. 1. The magnet retention core 120 presents a central axis of the orifices 140, 141 in an arrangement that is perpendicular to a central axis of the orifices 130, 131 and to the central tubular fuel conduit passage 123. The magnets 152, 153 are inserted into the orifices 140, 141, wherein each of the magnets 152, 153 are oriented arranging the north magnetic poles 154 proximate the tubular fuel conduit 110.

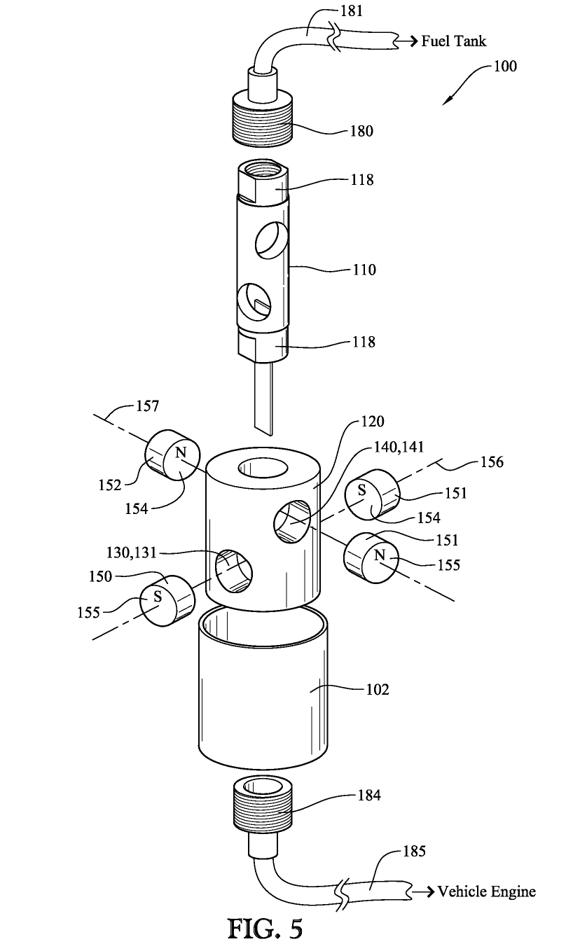

An exploded assembly view of the fuel saver and contaminant reduction device 100 is illustrated in FIG. 5. The illustration presents the various components of the contaminant reduction device 100 and introduces an assembly interface between the contaminant reduction device 100 and a fuel system of a vehicle (not illustrated). One connector 118 of the tubular fuel conduit 110 defines a fuel inlet, which is configured in fluid communication with the fuel tank of a vehicle (not illustrated), through a connector 180 and a fuel tank source hose 181. In turn, a second connector 118 located at the opposite end of the same tubular fuel conduit 110 is configured in fluid communication with the fuel line feeding fuel to a vehicle's engine (not illustrated) through a similar connector 184 and an engine fuel supply hose 185. The cylindrical wall 102 covers and protects the cylindrical housing 120, the orifices 130, 131 and 140, 141 and the permanent magnets 150, 151, 152 and 153 inserted therein. It can also be clearly seen how the north poles 151 of each magnet 150 are inserted facing one another.

When the vehicle's engine is running and the fuel pump is transferring fuel from the tank to the feeding system and ultimately the engine, the fuel passes through the pipe 110. Fuel molecules are affected by two different orthogonal magnetic fields: the magnetic field created by magnets 150, 151 assembled within orifices 130, 131 in accordance with the magnetization axis 156, and the magnetic field created by the magnets 152, 153 assembled within orifices 140, 141 in accordance with the magnetization axis 157. Since the two pairs of magnets (150, 151) and (152, 153) are separated by a short distance within the 100#, the fuel molecules flowing through the passage 123 towards the vehicle's engine are affected in a short period of time by two different magnetic fields, creating a notable molecular agitation.

This agitation effect of the fuel molecules creates a molecular rearrangement optimizing the combustion process in internal combustion engines, burners in furnaces and boilers, turbines and the like. As a secondary result, the impurities created by the combustion process are also reduced significantly.

Under the action of a magnetic field created by the magnets 150,151, 152, 153, the fuel molecules flowing through the passage 123 are rearranged and realigned. The two pairs of permanent magnets (150, 151) and (152, 153) create two changes in the molecular orientation of the fuel; improving the reorganization and alignment as well as giving a rotational movement. This effect dramatically changes the properties of the fuel, additives and impurities, which results in a considerable reduction in fuel consumption and also a remarkable reduction on discharged or exhausted contaminants, basically pollutant levels and CO2 emitted.

In the preferred embodiment illustrated in FIGS. 1-5, the magnetization axis 156 of magnets 150, 151 assembled within the orifices 130, 131 is perpendicular to the axis of magnetization 157 of the magnets 152, 153 assembled within orifices 140, 141, but this should not be interpreted as a limitation of the present invention, as the magnetic fields of the two sets of permanent magnets (150, 151) and (152, 153) may be offset at any angle.

Additionally, although two pair of orifices 130, 131 and 140 141 are illustrated herein, it is understood that any number of orifices and respective magnets can be integrated within the design, wherein the pairs would be arranged at any angle between each other, without departing from the original scope of protection.

The permanent magnets 150, 151, 152, 153 may also be replaced by or supplemented in whole or in part by electromagnets or any other material or device that generates a magnetic field. The magnetic fields created by the magnets may also be increased, focused or directed by inserting metal pieces into the orifices in which the magnets are inserted.

Finally, the present fuel saver and contaminant reduction device 100 is illustrated and described as a standalone device installed to the fuel circuit of a vehicle. In accordance with another embodiment (not illustrated), the device may be installed directly around the fuel pipe of the fuel circuit.

While the preferred embodiments of the invention have been described above, it will be recognized and understood that various modifications can be made in the invention and the appended claims are intended to cover all such modifications which may fall within the spirit and scope of the invention.

What is claimed is:

1. A fuel saver and contaminant reduction device, comprising:
a magnet retention core comprising at least two pair of transversally aligned orifices and an axially located orifice passing therethrough;
a tubular fuel conduit forming a fuel conduit, the tubular fuel conduit comprising a fuel inlet located at a first end, and a fuel discharge located at a second end, the tubular fuel conduit being assembled through the axially located magnet retention core orifice;
two pair of magnets, each magnet having a distinct north magnetic pole and a distinct south magnetic pole, wherein each pair of permanent magnets is arranged orienting the north magnetic pole of each magnet facing one another, and the axis of magnetization is oriented perpendicular to the tubular fuel conduit;
the cylindrical body is covered by an external case retaining each magnet within each respective orifice.

2. The fuel saver and contaminant reduction device of claim 1, wherein the permanent magnets are electromagnets.

3. The fuel saver and contaminant reduction device of claim 1, wherein the magnetic fields created by the magnets are increased, focused and directed by inserting metal pieces into the orifices in which the magnets are inserted.

4. The fuel saver and contaminant reduction device of claim 1, wherein any number of orifices and respective magnets are integrated within the design, wherein the pairs would be arranged at any angle between each other.

5. The fuel saver and contaminant reduction device of claim 1, wherein the magnetic fields of the two sets of permanent magnets are offset at any angle.

6. The fuel saver and contaminant reduction device of claim 1, wherein the device is installed directly around the fuel pipe of the fuel circuit.

7. The fuel saver and contaminant reduction device of claim 1, wherein the device is a standalone device installed to the fuel circuit of a vehicle.

8. The fuel saver and contaminant reduction device of claim 1, wherein the magnets in each orifice are inserted deep into each orifice, being positioned proximate the tubular fuel conduit.

9. A fuel saver and contaminant reduction device, comprising an external casing having a lateral cylindrical wall terminating at a base and a separate upper casing removable cover, the base is integrated into the lateral cylindrical wall, a tubular fuel conduit is arranged extending axially outward from the casing removable cover, and is configured to include a connector formed at each end thereof, wherein the connector is designed to connect the device to the fuel system of the vehicle; the tubular fuel conduit is inserted into a magnet retention core, which is assembled sandwiched between an exterior surface of the tubular fuel conduit and an interior surface of the external casing.

10. The fuel saver and contaminant reduction device of claim 8, wherein the magnet retention core includes a longitudinal orifice, and includes at least two pair of linearly aligned transversal orifices.

11. The fuel saver and contaminant reduction device of claim 9, wherein the first pair of orifices are located proximate a first end of the pipe, and the second pair of orifices are located proximate a second, opposite end of the pipe.

12. The fuel saver and contaminant reduction device of claim 10, wherein the geometrical axis of the first pair of orifices is perpendicular to the geometrical axis of the second pair of orifices.

13. The fuel saver and contaminant reduction device of claim 11, wherein a plane defined by the geometrical axis is, in turn, perpendicular to the geometrical axis of the pipe.

14. The fuel saver and contaminant reduction device of claim 8, wherein the magnets in each orifice are inserted deep into each orifice, being positioned proximate the tubular fuel conduit.
